(19) United States
(12) Patent Application Publication
(10) Pub. No.: US 2026/0367379 A1
(43) Pub. Date: Nov. 19, 2026

(54) Microscope

(71) Applicant: Carl Zeiss Microscopy GmbH, Jena (DE)

(72) Inventors: Daniel Schwedt, Weimar (DE); Christoph Eichhorn, Großschwabhausen OT Hohlstedt (DE); Tiemo Anhut, Jena (DE); Michael Goelles, Jena (DE)

(21) Appl. No.: 19/148,410

(22) PCT Filed: Jan. 5, 2024
(86) PCT No.: PCT/EP2024/050184

§ 371 Date: Jul. 16, 2025

(30) Foreign Application Priority Data
Jan. 17, 2023 (DE) 10 2023 100 926.5

(51) Int. Cl. G02B 21/00

(52) U.S. Cl. CPC G02B 21/0076; G02B 21/0032; G02B 21/0064; G02B 21/008

(57) ABSTRACT

A microscope comprising a light source for transmitting excitation light, an illumination beam path for guiding the excitation light onto and/or into a sample, a scanning device for varying a site on and/or in the sample exposed to the excitation light, at least one two-dimensionally spatially resolving detector for detecting light emitted by the sample, a detection beam path with a microscope objective for guiding at least a portion of the light emitted by the sample to the detector, a control unit for controlling the scanning device and for evaluating measurement data from the detector. The microscope includes a detection unit, which contains the detector and has an optical unit of varying focal length for imaging the sample with variable magnification on the detector and a controllable and optionally activatable dispersing device for spectrally separating at least a portion of the light emitted by the sample, wherein the control unit is also configured to control the dispersing device.

The invention relates to a microscope according to the preamble of Claim 1.

A generic microscope comprises a light source for transmitting excitation light, an illumination beam path for guiding the excitation light onto and/or into a sample, a scanning device for varying a site on and/or in the sample exposed to the excitation light, at least one two-dimensionally spatially resolving detector for detecting light emitted by the sample, a detection beam path with a microscope objective for guiding at least a portion of the light emitted by the sample to the detector, and a control unit for controlling the scanning device and for evaluating measurement data from the detector. A microscope of this type is known from DE 10 2020 120 190A1 , for example.

Laser scanning microscopy is the outstanding tool for examining three-dimensional samples, as it suppresses out-of-focus light due to the spatial filtering at the confocal stop to generate very high-contrast images of any sample. In recent years, various measurement methods have been developed for this technology, such as spectral imaging with spectrometer-like detectors (DE 10 038 528A1 ) or high-resolution imaging by means of spatial oversampling of the point spread function (PSF) with a camera-like sensor, known as Image Scanning Microscopy (ISM) (DE 10 2020 120 190A1 ).

Due to this variety of different measurement modes, laser scanning microscopes (LSM) are often complex and expensive. Therefore, it is hardly possible in terms of costs for commercially available technology to combine spectral imaging and spectrally multi-channel ISM in one LSM system. In addition, the detection efficiency often decreases with the number of measurement modes integrated in a system. So far, it is thus only possible to produce spectrally multi-channel image recordings either with lower resolution only or sequentially in what is known as a multitrack mode with commercially available LSM systems.

In 2021, reports featured ISM with a 5×5 pixel SPAD array. Such and similar sensors are already commercially available. This means in essence that sensors are available that offer access to ISM with a significantly smaller construction size than multi-anode PMTs.

Currently, the number of pixels available in commercial SPAD arrays which can be used for scanning microscopy is rather limited right now. However, this is not a limitation in principle and is rather due to limited data rates. It is foreseeable that the number of pixels of these CMOS SPAD camera sensors will increase significantly within a few years. There are already CMOS SPAD arrays with 1 million pixels (https://doi.org/10.1117/12.2589786 and https://doi.org/10.1364/OPTICA.386574).

An object of the invention can be considered that of specifying an arrangement which, with a simplified setup, allows both spectral imaging and ISM.

This object is achieved by the microscope having the features of Claim 1.

The abovementioned microscope is further developed according to the invention in that a detection unit is present which comprises the detector and an optical unit of varying focal length for imaging the sample with variable magnification on the detector and a controllable and optionally activatable dispersing device for spectrally separating at least a portion of the light emitted by the sample, wherein the control unit is also configured for controlling the dispersing device.

Preferred exemplary embodiments of the microscope according to the invention will be explained below, in particular in the context of the dependent claims and the figures.

The present invention is based on the finding that fast two-dimensionally resolving detectors, in particular SPAD arrays, can be used on the one hand as a camera for over-sampled detection of the PSF and on the other hand also for detecting the spectrum of the emission emitted from a sample.

A basic concept of the present invention can be considered that of enhancing a microscope with a two-dimensionally spatially resolving detector by providing a variable magnification in the detection beam path on the one hand and a variably activatable dispersing device in the detection beam path on the other hand both for image scanning microscopy and for spectral imaging.

An essential advantage of the present invention can be considered that of being able to implement the measurement modes image-scanning microscopy on the one hand and spectral imaging on the other hand with one and the same apparatus and thus with reduced layout in terms of apparatus in comparison to the prior art.

The excitation light is electromagnetic radiation, in particular in the visible spectral range and adjoining ranges. The only demand placed on the contrast-providing principle by the present invention is that the sample emits emission light as a consequence of being irradiated with the excitation light and/or deflects, scatters or reflects back the excitation light. Typically, the emission light is fluorescent light which the sample, in particular dye molecules present there, emits or emit as a consequence of being irradiated with the excitation light.

At least one light source, for example a laser, is present for the provision of the excitation light. The spectral composition of the excitation light can be adjustable, in particular between two or more colours. The excitation light can also simultaneously be polychromatic, for example if different dyes are intended to be detected simultaneously.

The term illumination beam path denotes all optical beam-guiding and beam-modifying components, for example a microscope objective, lenses, mirrors, prisms, gratings, filters, stops, beam splitters, modulators, for example spatial light modulators (SLM), by means of which and via which the excitation light from the light source is guided to the sample to be examined. Beam-modifying components also include dispersive and, in particular, diffractive elements that cause optical dispersion, for example structures such as gratings or volume holograms that may in part have a spatially periodic structure in particular.

Light that is emitted and/or deflected, for example scattered, by the sample to be examined as a consequence of the latter being irradiated with the excitation light may be referred to as emission light and reaches the at least one detector via the detection beam path.

The term “detection beam path” denotes all beam-guiding and beam-modifying optical components, for example objectives, lenses, mirrors, prisms, gratings, filters, stops, beam splitters, modulators, for example spatial light modulators (SLM), by means of which and via which the emission light is guided from the sample to be examined to the detector. The microscope objective is part of the detection beam path.

Imaging the sample means that at least part of the sample is imaged. The visible region is delimited by the field of view of the sensor and/or by field stops optionally present in the detection beam path.

The term control unit denotes all hardware and software components which interact with the components of the microscope according to the invention for the intended function thereof. In particular, the control unit can comprise a computing device, for example a PC, and a camera controller capable of rapidly reading out measurement signals. The computer resources of the control unit can be distributed among a plurality of computers and optionally a computer network, in particular also via the Internet. The control and evaluation unit can comprise in particular customary operating equipment and peripherals, such as a mouse, keyboard, screen, storage media, joystick, Internet connection. The control unit can in particular read the image data from the detector and can also be configured and serve to control the light source. According to the invention, the control unit is also configured for controlling the dispersing device. The control unit can also be configured to adjust the magnification using the optical unit of variable focal length.

In typical exemplary embodiments, the illumination beam path and/or the detection beam path in the microscope according to the invention comprise(s) at least one of the following components: main beam splitter, scanning optical unit, tube lens. Parts of the illumination beam path and the detection beam path may be provided by the same optical components. A beam splitter that separates excitation light from emission light, i.e. from light emitted by the sample, is referred to as a main beam splitter. Typically, the detection beam path thus contains hardly any or no components of excitation light downstream of the main beam splitter. The at least one detector in the detection unit therefore cannot be flooded by excitation light. The main beam splitter can be a dichroic beam splitter.

The sample can be illuminated using a separate optical unit, in particular via a separate microscope objective. Generally, however, the sample is illuminated by one and the same microscope objective, which is also a constituent part of the detection beam path.

The scanning device may comprise a two-dimensional scanner arranged in the illumination beam path. This scanner can also be a constituent part of the detection beam path, i.e. the light that is emitted by the sample and is to be detected is descanned. For example, the two-dimensional scanner can be a galvo scanner. In addition or as an alternative, the scanning device may comprise an actuable laterally displaceable sample stage. The sample stage can advantageously be laterally displaceable in two independent coordinate directions, each perpendicular to a direction of an optical axis of the microscope objective. The scanning device can also be realized by a combination of a two-dimensional scanner with a laterally displaceable sample stage.

In a preferred exemplary embodiment, the detection unit comprises an aperture stop with adjustable size. The aperture stop can perform two functions. Firstly, out-of-focus emission light can be stopped down thereby, and, secondly, it acts as an entrance opening for a spectrally dispersive mode, which is described in detail below. In the spectrally resolving or dispersive mode, the size of the entrance opening influences the spectral resolution and, should multiple spectral detection channels be present, the separation of the detection channels. Advantageously, an entrance optical unit may also be present in order to generate an intermediate image plane in which the aperture stop can be positioned.

In a particularly preferred exemplary embodiment, the optical unit of variable focal length images one and the same plane of the sample onto the detector or the detectors, independently of a focal length setting. This achieves the advantage that the detector or the detectors can in each case remain at the same site independently of the setting of the optical unit of variable focal length.

The optical unit of variable focal length can be formed by a zoom optical unit. The advantage achieved in this context is that the magnification of the imaged sample plane can be adjusted particularly finely. In particular, the magnification can be set particularly precisely to an advantageous value in view of the parameters of a pixel distance of the at least one used detector and in view of the extent of the point spread function.

The term “point spread function” refers to that intensity distribution of the light to which e.g. a lens transfers an incoming parallel beam that fills a specific used diameter of the lens. This function is routinely abbreviated PSF (point spread function). The used diameter of the lens used may but need not be the maximum possible diameter. This means that the PSF need not correspond to a full use of the maximum numerical aperture available. Should the numerical aperture not be fully utilized, the extent of the PSF is increased in comparison with the maximum utilization.

However, it is also possible that the optical unit of variable focal length is formed by a lens interchange system, by means of which the magnification can be set to a plurality of discrete values. This may be sufficient for many applications.

A particular advantage of the invention shown here is that the detection unit can be upgraded to spectrally multi-channel variants with comparatively little effort. A particularly preferred exemplary embodiment is thus characterized in that formed in the detection unit is a first detection channel, which comprises at least the detector, in that present in the detection unit is at least one further detection channel, in that each further detection channel has a two-dimensionally spatially resolving detector, and in that at least one colour splitter is present in the detection beam path for guiding a spectral component of the light that is emitted by the sample and is to be detected into the respective further detection channel.

In the simplest spectrally multi-channel variant, a colour splitter with a filter edge, which splits the light to be detected, based on the filter edge, at least into a long-wave and a short-wave component, may be present. The short-wave component then enters, for example, the first detection channel and the long-wave component accordingly enters the second detection channel. In particular, the colour splitter can be a dichroic beam splitter.

In order to be able to adapt the distribution of the spectral components over the detection channels to a sample, it is advantageous if the spectral position of the filter edge of the dichroic splitter can be varied discretely or particularly advantageously continuously. However, the colour splitter can also be realized by a filter arrangement with many filter layers, at which the light to be detected is reflected an appropriate number of times (interference filter, for example bandpass filter).

The at least one controllable and optionally activatable dispersing device for spectrally separating light to be detected is designed for the spectral separation of light to be detected. Spectral separation refers to a spectral decomposition in such a way that the spectral components of the light are radiated in different spatial directions after passing through a device for spectral separation, depending on the wavelength of the respective component.

The separation can be achieved using diffraction and/or refraction. The property of the dispersing device to be optionally activated refers to the fact that it optionally either separates the light to be detected in the detection beam path or not. In preferred embodiments, the dispersing device for this purpose is inserted into the detection beam path or removed therefrom. Alternatively or additionally, the detection beam path is redirected so that the dispersing device in question is part of the redirected detection beam path. The property of the dispersing device to be controllable refers to the fact that the optional activation can be controlled by the control unit.

For the implementation of the invention, it is sufficient if only a single controllable and optionally activatable dispersing device for spectrally separating light to be detected is present. In the case of a multi-channel detection unit, the dispersing device can be arranged in the detection beam path upstream of the at least one colour splitter or the colour splitters. The device then acts on all spectral channels together.

Advantageously, the controllable and optionally activatable dispersing device for spectrally separating light to be detected may also be effective only in one of the detection channels and/or at least one further controllable and optionally activatable dispersing device for spectrally separating light to be detected, which is effective only in one of the detection channels, may be present. For example, the dispersing device present according to the invention may be part of the first detection channel.

Where this description refers to the fact that at least one component may have a specific property or a specific feature, this also means that several or all components of the respective type may have the respective property or the respective feature.

For example, in an advantageous variant, a controllable and optionally activatable dispersing device for spectrally separating light to be detected can also be present in each individual detection channel. This has the advantage that the spectral dispersion can be specifically set in each individual detection channel. For example, the dispersing devices to be respectively used in the individual detection channels and the colour splitters can be matched to one another. This variant is particularly advantageous when prisms are used as dispersion elements, because their spectral dispersion decreases with increasing wavelength.

The controllable and optionally activatable dispersing device for spectrally separating light to be detected may, in particular in at least one or for at least one detection channel, comprise at least one of the following components or be formed by one of the following components: a grating insertable in the detection beam path, in particular by pivoting, in particular transmission grating or reflection grating, a prism insertable in the detection beam path, in particular by pivoting, in particular straight-view prism or Pellin-Broca prism. The dispersing device may also comprise a holographically produced component. Alternatively, a controllable and optionally activatable dispersing device may also be realized when the detection beam path for activating the dispersing device is redirected in such a way, for example with pivotable mirrors, that the dispersing device is then part of the redirected detection beam path. The dispersing device should then also be considered to be insertable. In this case, the dispersing device itself may, but does not have to, be fixed in place.

In order to switch to a spectrally detecting mode, in the simplest case, the spectrally dispersing device is inserted into the beam path.

Advantageously, when switching to spectral imaging, the magnification of the image representation from the sample to the two-dimensional spatially resolving detector is adapted such that the full width at half maximum (FWHM) of the PSF is of the order of a few pixels, ideally of only one pixel or even less, in order to be able to simultaneously measure a spectral range that is as large as possible. In addition, the spectral resolution of the detection system can be improved by shifting the spectrum over the sensor for two consecutive image recordings and their subsequent computation.

In microscopy, it is generally always desirable to obtain reasonable grey values for the images to be recorded. In other words, the aim is to make reasonable use of the capacity of detectors used, i.e. operate them neither in the saturation range, where the proportionality of the measurement signal to the amount of light is lost, nor at very low count rates, where the signal is small in comparison with detector noise.

In this respect, it should also be noted that the count rate of the detectors used is typically limited to a few megahertz and to a few 10 MHz at best. For SPAD arrays, the physical reason for the limited count rate lies in the photon-counting nature of the SPAD pixels with their inherent dead time during the avalanche quenching. In order to obtain reasonable grey values in the generated images at pixel dwell times of approximately 1 microsecond or less typical in laser scanning microscopy, it may therefore be advantageous to distribute the emission of a dye over a plurality of pixels of the detector. To a certain extent, this is already achieved by spectral dispersion. Further improvements are possible in this respect in a further particularly preferred exemplary embodiment, in which in the detection unit and/or in at least one detection channel, a cylindrical optical unit that can optionally be inserted into the detection beam path is present, said cylindrical optical unit axially displacing an image plane for a direction that is perpendicular to a direction in which the dispersing device of the respective detection channel causes the spectral splitting. The axial displacement of the image plane, consequently in the direction of the optical axis, causes the light of a wavelength range to be detected to be distributed among a plurality of pixels of the detector. In extreme cases, the light of a wavelength range to be detected can be distributed among all pixels in the relevant row or column of the detector. The cylindrical optical unit that can be inserted, in particular by pivoting, can be used to defocus the PSF in the axis oriented perpendicular to the dispersion direction and thus extend said PSF over many pixels on the detector.

It is possible for only a single cylindrical optical unit that can optionally be inserted to be present; it can be arranged in the detection beam path upstream of the at least one colour splitter or colour splitters. This cylindrical optical unit then acts on all spectral channels together. In another advantageous variant, a separate cylindrical optical unit that can optionally be introduced is present in each of a plurality of detection channels or in each individual detection channel. The distribution of the PSF among the pixels of the detector can then be implemented on an individual basis in the corresponding channels or in each channel. If need be, different cylindrical optical units can also be used in the various detection channels. At least one of the cylindrical optical units may comprise at least one cylindrical lens or may be realized by at least one cylindrical lens.

In a further preferred embodiment of the invention, the detection unit and/or at least one of the detection channels comprises a filter that is adjustable in relation to its spectral transmission and/or reflection properties. This filter can serve to set the spectral detection bandwidths for ISM, for example, and limit them to the dyes selected in each case.

In this case, it is particularly preferable for at least one of the filters to have a setting in which the light is transmitted and/or reflected over a broad bandwidth. This setting can then advantageously be selected for spectrally resolving measurement modes. For example, at least one of the filters may have a plurality of discrete filter segments, each of which can be inserted into the detection beam path. In an alternative to that or in addition, at least one of the filters may be realized by a continuously adjustable filter in a different embodiment.

In a further particularly preferred configuration, an adjustable optical unit for laterally shifting spectrally separated light relative to the detector of the respective detection channel is present in the detection unit and/or in at least one detection channel. With the adjustable optical unit for laterally shifting spectrally separated light, the offset of a partial spectrum in a detection channel on the detector of this detection channel can be adjusted particularly advantageously.

The adjustable optical unit for lateral shifting may comprise at least one of the following components in the detection unit and/or in at least one detection channel or be realized by one of the following components: adjustable tiltable mirror, adjustable tiltable plane-parallel transparent plate, in particular glass plate. This allows for an optimal offset of a spectral range in each case relevant to the excited fluorophores on each of the individual detector sensors.

The mechanical manipulation of components in the beam path, such as pivoting in and out, pushing in, pulling out of the beam path and tilting, can be realized in a generally known manner by actuable motorized drives.

Pixelated detectors, in particular SPAD array detectors, usually have a fill factor of less than 1, which means that the detectors have regions between the pixels where incident photons are not detected. Consequently, the detectors can detect incident photons only on a fraction of the detector surface. To compensate for this property, the detector can be provided with a microlens array, wherein each pixel, for example each SPAD pixel, may be assigned a microlens. In a preferred variant, a multi-lens array is arranged at least in front of one detector. The arrangement in front of a detector means that the multi-lens array is located upstream of the detector in the beam path, that is, the light to be detected passes through the multi-lens array before it is incident on the detector. A multi-lens array can be arranged on the associated detector. The multi-lens array and the associated detector can then form a structural unit.

In a preferred exemplary embodiment, pixels, in particular adjacent pixels, for example in the direction of the detector rows and/or detector columns, may be combined by binning in at least one of the detectors. When each individual pixel of a detector is read separately, each pixel provides a separate detection signal corresponding to the amount of light to be detected which arrives at the respective site of the pixel. When multiple pixels are combined by binning, a single “bin” provides a detection signal that equals the sum of the amount of light to be detected that arrives on the pixels forming the “bin”. The number of detection signals to be evaluated is thus reduced and the reading of the detectors can be accelerated. It is advantageous to combine entire pixel rows and/or entire pixel columns by binning. Depending on the measurement task, it may be useful to combine by binning pixels in a direction perpendicular to the direction of spectral dispersion. In this case, the spectral resolution is maintained while achieving a high dynamic by using multiple detector elements, and a reduction in the data rate. For other measurement tasks, it may be useful to combine pixels in the direction of spectral dispersion. This reduces the spectral resolution, but the reading speed and thus a frame rate can be increased. Furthermore, both described binning methods can also occur in combination.

It is also advantageous to define spectral channels on the sensor by binning. For example, two dyes with a bandwidth of 50 nm each can be detected, which emit at, for example, 500 nm and 580 nm respectively. Then two bins can be spanned that correspond to the wavelength ranges 500 +/−25 nm and 580 +/−25 nm. Each of the two bins then corresponds to one spectral channel and all other data are discarded or otherwise binned and transferred.

The at least one two-dimensionally spatially resolving detector is a sufficiently fast optical detector having a two-dimensionally spatially resolving sensor surface. In particular, the detector can be a camera, in particular with a CCD, sCMOS, CMOS or SPAD camera chip or SPAD array. Particularly preferably, the respective detector in each detection channel can have a SPAD array. A number of properties of fast two-dimensionally resolving detectors, in particular SPAD arrays, form the basis for their preferred use. For example, these detectors can detect the fluorescence signal in a temporally resolved manner. Since fluorophores very often also differ in their fluorescence lifetime, the inclusion of this parameter in the mathematical separation problem is advantageously possible. Furthermore, sensor elements can be flexibly switched on and off. Flexible switching patterns for a pixel matrix are described for such applications in WO2020207571A1.

The two-dimensionally spatially resolving detector and the corresponding optical setup are particularly suitable for detecting a PSF of the emission light laterally over-sampled, at least to meet the Nyquist theorem. This is particularly important if the method of so-called image scanning microscopy (brand name Carl Zeiss: Airyscan) is to be carried out. However, conventionally confocal measurements with this detector are also possible, for example by adding up the values of all or at least a larger number of pixels. The detectors may preferably have a rectangular or a hexagonal arrangement of the pixels.

In a particularly preferred configuration of the microscope according to the invention, a colour splitter device is provided with a rotor on which a plurality of colour splitters are arranged, wherein different colour splitters can be inserted into the detection beam path by setting different rotational positions of the rotor, via which colour splitters a spectral component of the light emitted by the sample can be supplied to each detection channel. This allows the detection channels to be arranged very compactly.

The colour splitters can be each configured such that at each of the colour splitters in turn a respective spectral component of the light is reflected and one component is transmitted, wherein the transmitted spectral components can be supplied to in each case one of the detection channels. The colour splitters can be bandpass filters in particular.

In an advantageous development of this colour splitter device, different groups of colour splitters can be insertable into the detection beam path by setting different rotational positions of the rotor.

Particularly advantageously, the colour splitters can be arranged on the rotor on the outer surface of a cylinder, wherein the axis of rotation of the rotor is collinear with a main axis of the cylinder and is oriented transversely, in particular perpendicularly, to a direction of incidence of the light on the colour splitter device. This achieves the advantage that, due to the stable rotation of the filter surfaces around the main axis of the cylinder, the beam direction of the resulting detection beam paths is maintained after a modified configuration. This is particularly advantageous due to the small sensor surfaces of typically significantly less than 1 mm² that are typical for SPAD array detectors, for example.

Further advantages and features of the present invention are described below in connection with the appended figures, in which:

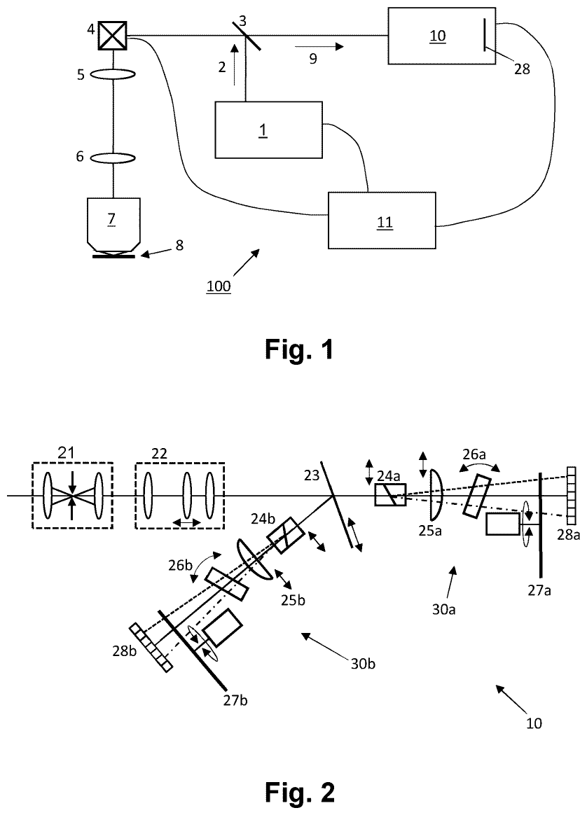

FIG. 1: shows a schematic illustration of a microscope according to the invention;

FIG. 2: shows a schematic illustration of an exemplary embodiment of a detection unit for a microscope according to the invention;

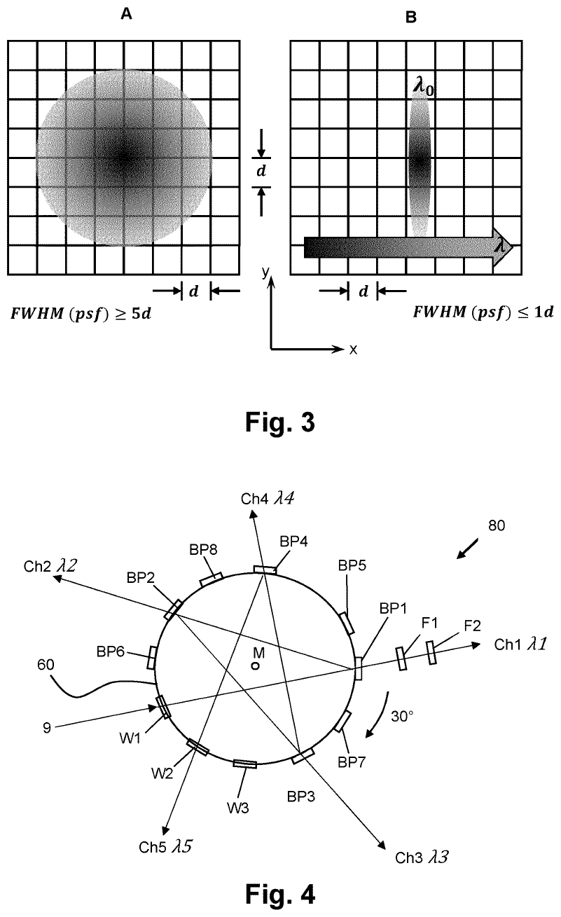

FIG. 3: shows diagrams for illustrating the irradiation of a two-dimensionally spatially resolving detector in different operating modes of the microscope according to the invention; and

FIG. 4: shows an exemplary embodiment of a filter device for a microscope according to the invention.

One exemplary embodiment of a microscope 100 according to the invention will be explained with reference to FIGS. 1 to 3. The microscope 100 shown schematically in FIG. 1 comprises as essential components a light source 1, an illumination beam path with a microscope objective 7, a detection beam path, a detection unit 10 and a control unit 11. The light source 1, which is typically a laser, in particular having a plurality of wavelengths, is used for emitting excitation light 2, which is directed onto and/or into a sample 8 to be examined via the illumination beam path. In the schematically shown example, the illumination beam path comprises a main beam splitter 3, a scanning device 4, a scanning optical unit 5, a tube lens 6 and the microscope objective 7. In the microscope 100, a stand for receiving a sample may be present in a known manner in a sample compartment under the microscope objective 7. The setup shown in FIG. 1 corresponds substantially to a laser scanning microscope (LSM) for sequential scanning and illumination of the sample 8 with an excitation laser as the light source 1.

Starting from the light source 1, the excitation light 2 initially reaches the main colour splitter 3 and is guided therefrom in the direction of the scanning device 4, which may be, for example, a two-dimensional galvo scanner. From there, the excitation light 2 passes via the scanning optical unit 5 and the tube lens 6 to the microscope objective 7, which focuses the excitation light 2 onto and/or into the sample 8.

Light 9 emitted by the sample 8, in particular as a result of the latter being irradiated with the excitation light 2, which can also be referred to as emission light 9, is guided via the detection beam path to the detection unit 10. The emission light may in particular be fluorescent light from dyes with which the sample 8 was prepared.

The first constituent part of the detection beam path is the microscope objective 7, which receives and collimates the emission light 9. Via the tube lens 6 and the scanning optical unit 5, the emission light 9 reaches the scanning device 4, is descanned there and then reaches via the main beam splitter 3, where it is transmitted, in contrast to the excitation light 2, to the detection unit 10 and is imaged fixedly therein on the two-dimensionally spatially resolving detector 28 provided according to the invention.

The control unit 11 serves in the exemplary embodiment shown at least for controlling the light source 1, the scanning device 4 and for evaluating measurement data from the detection unit 10, that is, from the at least one detector 28. For example, the control unit 11 can adjust the intensity of the excitation light 2 depending on a site on or in the sample 8 and optionally depending on an intensity of the emission light 9 coming from the sample site in question. Finally, the control unit 11 can, if necessary, generate images of the sample 8 after appropriate calculations with the measured data.

An exemplary embodiment of a detection unit 10 for a microscope 100 according to the invention will be explained with reference to FIG. 2. The detection unit 10 shown therein has as essential constituent parts a pinhole optical unit 21 with an adjustable size-variable aperture stop, an optical unit 22 of varying focal length present according to the invention, and a first spectral detection channel 30a and a second spectral detection channel 30b.

In the arrangement shown schematically in FIG. 2, the first detection channel 30a and the second detection channel 30b contain substantially the same optical components, which are optionally optimized for the different spectral compositions of the partial beams. Equivalent optical components in the two detection channels 30a and 30b are each denoted with the same reference signs, with the specification that the components of the first detection channel 30a are additionally provided with the letter a and those of the second detection channel 30b are additionally provided with the letter b.

In the first detection channel 30a and in the second detection channel 30b, a two-dimensionally spatially resolving detector 28a and 28b is present respectively, wherein each is a SPAD array detector in the exemplary embodiment.

The pinhole optical unit 21 generates an intermediate image plane in which the adjustable aperture stop, which can also be referred to as a pinhole, is arranged. The aperture stop can be used to suppress out-of-focus emission on the one hand and can also be used as an entrance opening for a spectral resolution mode on the other hand. In the latter case, the size of the opening of the aperture stop affects a spectral resolution and thus also a separation of the spectral detection channels.

Downstream of the pinhole optical unit 21 is the optical unit 22 of varying focal length, which is realized in the illustrated exemplary embodiment by a schematically illustrated zoom optical unit. The optical unit 22 of varying focal length is designed such that its back focal plane always lies in the plane of the SPAD detectors 28a, 28b. In other words, the planes of the SPAD detectors 28a, 28b are optically conjugate to the plane of the adjustable aperture stop. On the one hand, illumination of the detectors 28a, 28b after changing a microscope objective can be suitably adapted with the optical unit 22 of varying focal length. On the other hand, for a spectrally resolving measurement mode, the magnification from the plane of the adjustable aperture stop to the detectors 28a, 28b can be reduced in such a way that the FWHM of the PSF on the detectors 28a, 28b is of the order of magnitude of a distance d (see FIG. 3B) of the pixels of the detectors 28a, 28b or smaller in order to increase the spectral resolution. The size of the spectral range placed on the sensor depends on the angular dispersion generated in the prism and the distance between the prism and the sensor.

At a colour splitter 23, which may be, for example, a discretely or continuously adjustable dichroic beam splitter, the detection beam path is separated downstream of the optical unit 22 of varying focal length in the exemplary embodiment shown in FIG. 2 into the two detection channels 30a and 30b, which then carry different spectral ranges of the emission light 9 downstream of the colour splitter 23.

Directly downstream of the colour splitter 23, respective controllable and optionally activatable dispersing devices 24a, 24b are present, which serve for spectrally separating the emission light 9 in the first detection channel 30a and the second detection channel 30b. In the exemplary embodiment shown, the dispersing devices 24a and 24b are each realized by a displaceable combination of different glass wedges, which can be actuated by a motor to be moved in or out of the beam path. This movement is indicated by double-headed arrows. The emission light 9 is separated or spectrally fanned out downstream of the respective dispersing device 24a, 24b in a dispersion plane by the spectrally dispersing devices 24a, 24b, when these are in the beam path, i.e., are activated. In FIG. 2, the dispersion plane is identical to the drawing plane.

The spectrally separated emission light 9 is then incident on cylinder optical units 25a and 25b respectively, which shift the focus position for a direction perpendicular to the detection plane in such a way that the emission light 9 is distributed in the plane of the SPAD array detectors 28a, 28b perpendicular to the dispersion direction over many pixels (see FIG. 3B). The cylinder optical units 25a, 25b do not substantially change the focus in the dispersion direction. The image site in the dispersion direction is a function of the wavelength. This fact will be explained in more detail below in connection with FIG. 3B.

With angle-adjustable plane-parallel plates 26a, 26b, the spectrum generated with the dispersing devices 24a, 24b in each case can be shifted relative to the detectors 28a, 28b depending on the setting of the colour splitter 23 in each case in such a way that the spectral regions of interest are located as centrally as possible on the detectors 28a, 28b. For example, the spectra can be laterally shifted in such a way that a spectral centroid of the emission comes to lie in each case centrally on one of the detectors 28a, 28b, or that, as far as possible, the entire spectral emission bandwidth is detected by the respective detector 28a, 28b.

Finally, downstream of the components 26a, 26b, an adjustable filter 27a, 27b is respectively present, with which the spectral detection bandwidths for the first detection channel 30a and the second detection channel 30b can be set for the measurement mode Image Scanning (ISM).

In ISM operation, the dispersing devices 24a, 24b and the cylinder optical units 25a, 25b are removed from the beam paths in the directions indicated by the arrow directions and the adjustable filters 27a, 27b are advantageously set to positions which, together with the beam splitter 23, allow spectral discrimination of undesirable signals.

The movement of the dispersing devices 24a in the first detection channel 30a can be carried out together, but also independently of that of the dispersing device 24b in the second detection channel 30b. It is therefore possible to operate both detection channels 30a, 30b in ISM mode, both detection channels 30a, 30b in the spectral resolution mode, or the first detection channel 30a in ISM mode and the second detection channel 30b in the spectral resolution mode, or vice versa. This means that ISM data and spectral image data can be generated simultaneously.

Emission light reflected at the filters 27a, 27b can also be directed to further detectors, which are not shown in FIG. 2. As already described above, a reflection of spectral components of the detection light into further detection channels can also be carried out using further colour splitters, which can be arranged, for example, downstream of the colour splitter 23 and in front of one or both of the components 24a, 24b.

In the dispersive mode, the adjustable filters 27a, 27b can be advantageously set to positions in which, as far as possible, only broadband reflection-reducing layers are located in the beam path.

The order of the optical components in the detection channels 30a, 30b can be a different one, without this resulting in any restrictions regarding the described function. However, because of the focusing effect of the cylinder optical units 25a, 25b, it is useful to arrange these in each case downstream of the dispersing devices 24a, 24b.

In front of the detectors 28a, 28b, a multi-lens array may be present for compensating a finite fill factor of these detectors, which is not shown in FIG. 2. Each pixel of the detectors 28a, 28b can be assigned a microlens. Preferably, SPAD array detectors with a multi-lens array are used, which have a large acceptance solid angle on their input side, in order to image the spectra generated by the dispersing devices 24a, 24b and the cylinder optical units 25a, 25b, which are angularly separated, as completely as possible onto the respective active surface of the detectors 28a, 28b. For this purpose, a focal length of the lenses of the multi-lens array must not be selected to be too small, so that a change in the angle of incidence does not cause too large a change in the image offset. In addition, care should be taken that an image representation of the system pupil generated on the active surface areas of the detectors 28a, 28b is significantly smaller than the sensor surface area belonging to a single pixel. The SPAD array detectors 28a, 28b used can have a good sensitivity over an entire wavelength spectrum; but they can also be optimized for specific ranges of the optical spectrum which is to be detected in the respective detection channel.

In Figures A and B of FIG. 3, sensor surfaces with typical light distributions for ISM operation (FIG. 3A, left) and the spectral resolution operation (FIG. 3B, right) are respectively shown schematically.

In the examples shown, the pixels of the detector are arranged at right angles. However, hexagonal or other arrangements are also possible. In FIG. 3A, the PSF of the emission light 9 is positioned on the detector surface approximately in such a way that an intensity maximum of the PSF is located approximately centrally on the detector. This ensures that the intensity of the PSF at the periphery of the detector has subsided as far as possible. In addition, the magnification of the image representation is selected by suitable adjustment of the optical unit 22 of varying focal length (see FIG. 2) in such a way that the PSF, more precisely the diameter of the first Airy ring, with at least five pixels or five bins of pixels is sampled. This issue is expressed by the relationship

FWHM (psf)≥5d,

in which d is the distance between the pixels of the detector (pixel pitch) or the bins of pixels. A bin of pixels, i.e. a group of in particular adjacent pixels which are combined into a bin, can be called a pixel bin.

FIG. 3B shows the arrangement of a PSF of light of a single wavelength λ₀ on the detector in the spectral resolution mode. As can be seen, the PSF has a strongly asymmetric shape due to the effect of the cylinder optical unit 25a or 25b. In FIG. 3B, the dispersion direction runs horizontally, i.e. along the x-direction (see coordinate system in FIG. 3). This means that the PSFs of other wavelengths, which are not shown in FIG. 3B, depending on whether the wavelength in question is greater or smaller than the wavelength λ₀, come to lie to the right or left of the PSF shown. With the optical unit 22 of varying focal length, a magnification is advantageously set for this mode in such a way that the FWHM of the PSF for a single wavelength, as can be seen from FIG. 3B, is smaller than a pixel distance d. In this way, an improved spectral resolution is obtained.. In addition, in order to ensure that as many pixels of the detector as possible contribute to the signal generation for the PSFs of the individual wavelengths and to provide a good dynamic of the grey values in the images, the PSF is defocused with the cylinder optical unit 25a, 25b perpendicular to the dispersion direction, i.e. in the y direction. As a result, many pixels are illuminated by light with the same wavelength λ₀ in the y-direction.

FIG. 4 shows an exemplary embodiment of a colour splitter device 80, with which incoming emission light 9 can be distributed over a total of five spectral detection channels Ch1, . . . , Ch5. The reference signs λ1 to λ5 indicate the wavelength spectra of the emission light 9 in the respective detection channels Ch1, . . . , Ch5. Each of the reference signs λ1 to λ5 can represent a finite spectral range and also a plurality of non-contiguous spectral ranges.

The colour splitter device 80 has a rotor 60 on which, distributed over a circumferential direction of an outer surface of a cylinder, initially colour splitters BP1, . . . , BP4 are arranged, which form a first group of colour splitters. In the situation shown in FIG. 4, the colour splitters BP1, . . . , BP4 of this first group are located in the beam path. An axis of rotation of the rotor 60, which extends through a point marked with M perpendicular to the paper plane, is collinear with a main axis of the cylinder and is in particular oriented perpendicular to a direction of incidence of the emission light 9 on the colour splitter device 80.

In the situation shown in FIG. 4, the colour splitter device 80 operates as follows: Incoming emission light 9 enters through a window W1 and is incident on the first colour splitter BP1. A first spectral component λ1 is transmitted at the colour splitter BP1 and is decoupled into the first detection channel Ch1. A spectral component of the emission light 9 not transmitted by the colour splitter BP1 is substantially reflected by the colour splitter BP1 and is then incident on the second colour splitter BP2. There, a second spectral component λ2 is transmitted and decoupled into the second detection channel Ch2. In the same way, the process continues via the colour splitters BP3 and BP4, at which the spectral components λ3 and λ4 are decoupled into the third detection channel Ch3 and the fourth detection channel Ch4 respectively.

The remaining spectral component λ5 of the emission light 9, which is reflected at the fourth colour splitter BP4, enters the fifth detection channel Ch5 via an exit window W2.

In the exemplary embodiment shown, the entry window W1 and the exit window W2 are neutral, i.e. the light passing through is not spectrally changed there. However, it would be possible to provide filters there as well.

Assuming that no light is absorbed in the colour splitters BP1 to BP4 and the components W1 and W2, the incoming emission light 9 is completely divided among the detection channels Ch1 to Ch5.

A particularly advantageous property of the colour splitter device 80 shown in FIG. 4 is then obtained from the fact that further colour splitters BP5 to BP8 are additionally arranged on the outer surface of the cylinder 60, by which a second group of colour splitters is formed. By turning the cylinder 60 by 30° in the clockwise direction, it can be ensured that the component W2, which previously acted as an exit window, becomes the entry window for the incoming emission light 9. The beam path is then the same as described above, with the proviso that the colour splitters BP1, . . . , BP4 of the first group are replaced by the colour splitters BP5, . . . , BP8 of the second group and that a window W3 replaces the exit window W2. The colour splitters BP5, . . . , BP8 of the second group can have spectrally different properties in comparison with the colour splitters BP1, . . . , BP4 of the first group.

Switching from an examination of a first sample prepared with a first selection of dyes, in particular using a first spectrum of excitation light 2, to an examination of a second sample prepared with a second selection of dyes different from the first selection, in particular, using a second spectrum of the excitation light 2 different from the first spectrum, is particularly comfortable when using such a colour splitter device. A particular advantage is that, due to the stable rotation of the filter surfaces around the main axis of the cylinder, the beam direction of the resulting detection beam paths is completely preserved after setting another group of colour splitters. This is an important advantage, in particular when SPAD array detectors with sensor surface areas of typically smaller than 1 mm 2 are used.

In the exemplary embodiment shown, each group of colour splitters contains four colour splitters, which is not mandatory of course. Depending on the available space and the requirements of the experiment, more or fewer colour splitters and/or groups of colour splitters and correspondingly more or fewer spectral detection channels may be present.

The light coupled into the respective detection channels can be further conditioned before detection using filters. This is shown in FIG. 4 as an example for the first detection channel Ch1, where the filters F1 and F2 are positioned in the beam path.

### LIST OF REFERENCE SIGNS

1 light source
2 Excitation light
3 Main beam splitter, dichroic beam splitter
4 Scanning device, two-dimensional scanner
5 Scanning optical unit
6 Tube lens
7 Microscope objective
8 Sample
9 Light emitted by the sample 8, emission light
10 Detection unit
11 Control unit
21 Adjustable aperture stop
22 Optical unit of variable focal length, zoom optical unit
23 Colour splitter
24a Controllable and optionally activatable dispersing device of the first detection channel 30a
24b Controllable and optionally activatable dispersing device of the second detection channel 30b
25a Cylindrical optical unit, optionally to be inserted into the detection beam path in the first detection channel 30a
25b Cylindrical optical unit, optionally to be inserted into the detection beam path in the second detection channel 30b
26a Adjustable optical unit for lateral shift of spectrally separated light relative to the detector 28a
26b Adjustable optical unit for lateral shift of spectrally separated light relative to the detector 28b
27a Filter, adjustable with respect to spectral transmission and/or reflection properties
27b Filter, adjustable with respect to spectral transmission and/or reflection properties
28 Two-dimensionally spatially resolving detector
28a Two-dimensionally spatially resolving detector of the first detection channel 30a
28b Two-dimensionally spatially resolving detector of the second detection channel 30b
30a First detection channel
30b Further detection channel, second detection channel
60 Rotor
80 Colour splitter device
BP1, . . . , BP8 Colour splitter
BP1, . . . , BP4 First group of colour splitters
BP5, . . . , BP8 Second group of colour splitters
Ch1, . . . , Ch5 Detection channels
F1 Filter
F2 Filter
FWHM(psf) Full width at half maximum of the PSF
PSF, psf Point spread function
x Linear coordinate direction
y Linear coordinate direction
z Linear coordinate direction, direction of an optical axis z, in particular of the microscope objective 7
λ Wavelength
λ₀ Wavelength of the light of the illustrated intensity distribution
λi Wavelength spectrum of the emission light 9 in the detection channel i

### References

[1] DE10038528A1
[2] DE10201220A1
[3] M. Buttafava et al., Optica 7, 755(2020 ).
[4] https://piimaging.com
[5] WO2020207571A1

1. Microscope comprising:
a light source for transmitting excitation light,
an illumination beam path for guiding the excitation light onto and/or into a sample,
a scanning device for varying a site on and/or in the sample exposed to the excitation light,
at least one two-dimensionally spatially resolving detector for detecting light emitted by the sample,
a detection beam path with a microscope objective for guiding at least a portion of the light emitted by the sample to the detector,
a control unit for controlling the scanning device and for evaluating measurement data from the detector and
a detection unit, which includes the detector and has an optical unit of varying focal length for imaging the sample with variable magnification on the detector, wherein
the detection unit comprises a controllable and optionally activatable dispersing device in the detection beam path for spectrally separating at least a portion of the light emitted by the sample,
wherein the control unit is also configured to control the dispersing device.

2. Microscope according to claim 1,
wherein the detection unit comprises an aperture stop with an adjustable size.

3. Microscope according to claim 1,
wherein the optical unit of variable focal length images one and the same plane of the sample onto the detector or the detectors, independently of a focal length setting.

4. Microscope according to claims 1,
wherein the optical unit of varying focal length is formed by a zoom optical unit.

5. Microscope according to claims 1,
wherein the optical unit of variable focal length is formed by a lens interchange system, by means of which the magnification can be set to a plurality of discrete values.

6. Microscope according to claim 1,
wherein a first detection channel is formed in the detection unit, which comprises at least the detector,
wherein at least one further detection channel is present in the detection unit,
wherein each further detection channel has a two-dimensionally spatially resolving detector,
wherein at least one colour splitter is present in the detection beam path for guiding a spectral component of the light which is emitted by the sample and is to be detected into the respective further detection channel.

7. Microscope according to claim 6,
wherein the controllable and optionally activatable dispersing device for spectrally separating light to be detected is effective only in one of the detection channels and/or
wherein at least one further controllable and optionally activatable dispersing device for spectrally separating light to be detected is present, which is effective only in one of the detection channels.

8. Microscope according to claim 1,
wherein the controllable and optionally activatable dispersing device for spectrally separating light to be detected in at least one detection channel comprises at least one of the following components or is formed by one of the following components: a grating that can be pivoted into the detection beam path, a prism that can be pivoted into the detection beam path.

9. Microscope according to claim 1,
wherein in the detection unit, a cylindrical optical unit that can optionally be inserted into the detection beam path is present, with the cylindrical optical unit axially displacing an image plane in a direction that is perpendicular to a direction in which the dispersing device or one of the dispersing devices causes spectral splitting.

10. Microscope according to claim 1,
wherein the detection unit and/or at least one of the detection channels has a filter which is adjustable with respect to its spectral transmission and/or reflection properties.

11. Microscope according to claim 10,
wherein at least one of the filters has a setting in which the light is broadband transmitted and/or reflected.

12. Microscope according to claim 10,
wherein at least one of the filters has a plurality of discrete filter segments, each of which can be inserted into the detection beam path.

13. Microscope according to claim 10,
wherein at least one of the filters is realized by a continuously adjustable filter.

14. Microscope according to claim 1,
wherein the detector unit and/or in at least one detection channel, an adjustable optical unit for laterally shifting spectrally separated light relative to the detector of the respective detection channel is present.

15. Microscope according to claim 14,
wherein the adjustable optical unit in the detection unit and/or in at least one detection channel has at least one of the following components or is realized by one of the following components: adjustable tiltable mirror, adjustable tiltable plane-parallel transparent plate, electrically controllable element, which generates a phase gradient in such a way that a focus is laterally shifted.

16. Microscope according to claim 1,
wherein a multi-lens array is arranged in front of at least one of the detectors.

17. Microscope according to claim 1,
wherein in at least one of the detectors, pixels can be combined by binning.

18. Microscope according to claim 1,
wherein at least one of the detectors comprises a SPAD array.

19. Microscope according to claim 1,
wherein a colour splitter device is present with a rotor on which a plurality of colour splitters are arranged,
wherein by adjusting different rotational positions of the rotor, different colour splitters can be inserted into the detection beam path, via which a spectral component of the light emitted by the sample can be supplied to each detection channel.

20. Microscope according to claim 19,
wherein different groups of colour splitters can be inserted into the detection beam path by adjusting different rotational positions of the rotor, and/or
wherein the colour splitters are each configured to reflect one spectral component of the light in turn at each of the colour splitters and to transmit one component, and
wherein the transmitted spectral components can be supplied respectively to one of the detection channels.

21. Microscope according to claim 19,
wherein the colour splitters are arranged on the rotor on the outer surface of a cylinder and
wherein the axis of rotation of the rotor is collinear with a main axis of the cylinder and is oriented transverse to a direction of incidence of the light on the colour splitter device.
